(19) United States
(12) Patent Application Publication
(10) Pub. No.: US 2014/0142552 A1
(43) Pub. Date: May 22, 2014

(54) Percutaneous Feeding Tube Including a Rescue Port

(71) Applicant: Shaun M. Honig, New York, NY (US)

(72) Inventor: Shaun M. Honig, New York, NY (US)

(21) Appl. No.: 13/679,160

(22) Filed: Nov. 16, 2012

(51) Int. Cl. A61J 15/00

(52) U.S. Cl. CPC A61J 15/0019; A61J 15/0015
USPC 604/528; 604/539

(57) ABSTRACT

An enteral feeding device includes a first tube having a first proximal end, a first distal end, a first inner tube wall surface and a first exterior wall surface and a rescue port having a second proximal end, a second distal end, a second inner tube wall and a second exterior wall surface. The first exterior wall surface is adjacent to and integrally bonded to the second exterior wall surface

### CROSS REFERENCE TO RELATED APPLICATION(S)

N.A.

### U.S. GOVERNMENT RIGHTS

N.A.

### BACKGROUND

1. Field

This disclosure relates to percutaneous feeding tubes and more particularly to a rescue port, which in combination with a guide wire, is effective to accurately locate a replacement enteral feeding tube.

2. Description of the Related Art

Patients who cannot be fed by mouth will often need feeding tubes that go through the skin (percutaneous) and directly into the stomach or intestines (enteral) in order to receive nutrition and oral medication. The feeding tubes require replacement for a variety of reasons. One common reason to change a feeding tube is when the tube becomes clogged with thick material, such as food and/or ground-up medications. In order to change a feeding tube, an Interventional Radiologist may attempt to pass a wire through the feeding tube. The feeding tube will be removed over that wire and a new tube inserted over the wire so that the wire guides the insertion. When the feeding tube is clogged with thick material, it is almost always impossible to pass a wire through the tube. Therefore, replacement requires establishing a new access into the patient which increases procedure time, radiation dose to the patient and invasiveness of the procedure.

United States Published Patent Application Publication No. US 2011/0098660 A1, titled “Enteral Feeding Tube Having Unclogging Lumen,” to Porreca, Jr. discloses a feeding tube having an internal wall dividing the interior bore into a feeding lumen and an inflatable lumen. When a blockage forms in the feeding lumen, a fluid is introduced to inflate the inflatable lumen changing its shape and applying pressure to the blockage. Pulsing the inflatable lumen generates pressure changes that cause the blockage to break up. A second internal wall is illustrated to form a bypass lumen within the interior bore. The bypass lumen is disclosed as being intended to receive a guide wire or a de-kinking device, such as a rod. The disclosure of US 2011/0098660 A1 is incorporated by reference herein in its entirety.

A typical blockage is viscous and become cementitious over the span of a few days preventing insertion of a guide wire. The pressure exerted by the blockage may cause an internal bypass lumen to collapse preventing the free passing of a guide wire.

There remains, therefore, a need for a feeding tube capable of receiving a guide wire when a blockage is present that does not suffer from the limitations described above.

### BRIEF SUMMARY OF THE INVENTION

The details of one or more embodiments of the invention are set forth in the accompanying drawings and the description below. Other features, objects and advantages of the invention will be apparent from the description and drawings, and from the claims.

In accordance with a first embodiment, an enteral feeding device includes a first tube having a first proximal end, a first distal end, a first inner tube wall surface and a first exterior wall surface and a rescue port having a second proximal end, a second distal end, a second inner tube wall and a second exterior wall surface. The first exterior wall surface is adjacent to and integrally bonded to the second exterior wall surface.

In accordance with a second embodiment, a combination of an enteral feeding device and a guide wire includes a first tube having a first proximal end, a first distal end, a first inner tube wall surface and a first exterior wall surface; a rescue port having a second proximal end, a second distal end, a second inner tube wall and a second exterior wall surface, wherein the first exterior wall surface is adjacent to and integrally bonded to the second exterior wall surface; and a guide wire having a diameter effective to be received by the rescue port.

In accordance with a third embodiment, a process to replace an enteral feeding device includes the steps of (1) locating a first enteral feeding device in a patient, the first enteral feeding device having a first tube with a first proximal end, a first distal end, a first inner tube wall surface and a first exterior wall surface and a rescue port having a second proximal end, a second distal end, a second inner tube wall and a second exterior wall surface, wherein the first exterior wall surface is adjacent to and integrally bonded to the second exterior wall surface; (2) inserting a guide wire with a diameter effective to be received by the rescue port into the rescue port; (3) removing the first enteral feeding device while retaining the guide wire in place; (4) inserting a distal end of a second enteral feeding device rescue port around a proximal end of the guide wire; and (5) locating said second enteral feeding device in said patient.

### BRIEF DESCRIPTION OF THE DRAWINGS

FIG. 1 illustrates an enteral feeding device in longitudinal cross-sectional view.

FIG. 2 illustrates the enteral feeding device of FIG. 1 in axial cross-sectional view.

FIG. 3 illustrates a distal valve in accordance with an embodiment disclosed herein.

FIG. 4 illustrates the enteral feeding device of FIG. 1 including a guide wire.

FIG. 5 illustrates a first guide wire in axial cross-sectional view.

FIG. 6 illustrates a second guide wire in axial cross-sectional view.

FIG. 7 illustrates a third guide wire in longitudinal cross-section view.

Like reference numbers and designations in the various drawings indicated like elements.

### DETAILED DESCRIPTION

FIG. 1 illustrates an enteral feeding device 10 in longitudinal cross-sectional view. The enteral feeding device 10 includes a first tube 12 and a rescue port 14. The first tube 12 is for introducing nutrients and/or drugs into a patient and includes a proximal end 16 accessible to the health care provider for inserting require nutrients and/or drugs. First tube 12 terminates at an opposing distal end 18. When the enteral feeding device 10 is in use, distal end 18 is placed at a desired location through a patient's skin directly into the stomach (“gastrostomy,” tube referred to as a G-Tube), through the skin, into the stomach and continuing to the small intestine (“gastrojejunostomy”) and through the skin directly into the small intestine (“jejunostomy,” tube referred to as a J-Tube). The first tube 12 further includes a first inner tube wall 20 and a first exterior wall surface 22.

The rescue port 14 is for insertion of a guide wire to assist with replacement of the enteral feeding device 10 in the event the first tube 12 becomes blocked. Rescue port 14 has a proximal end 26 adjacent the proximal end 16 of the first tube 12 and a distal end 28 adjacent the distal end 18 of the first tube. A second tube 30 having a second inner tube wall 32 and a second exterior surface 34 extends from the rescue port 14 proximal end 26 to the rescue port distal end 28.

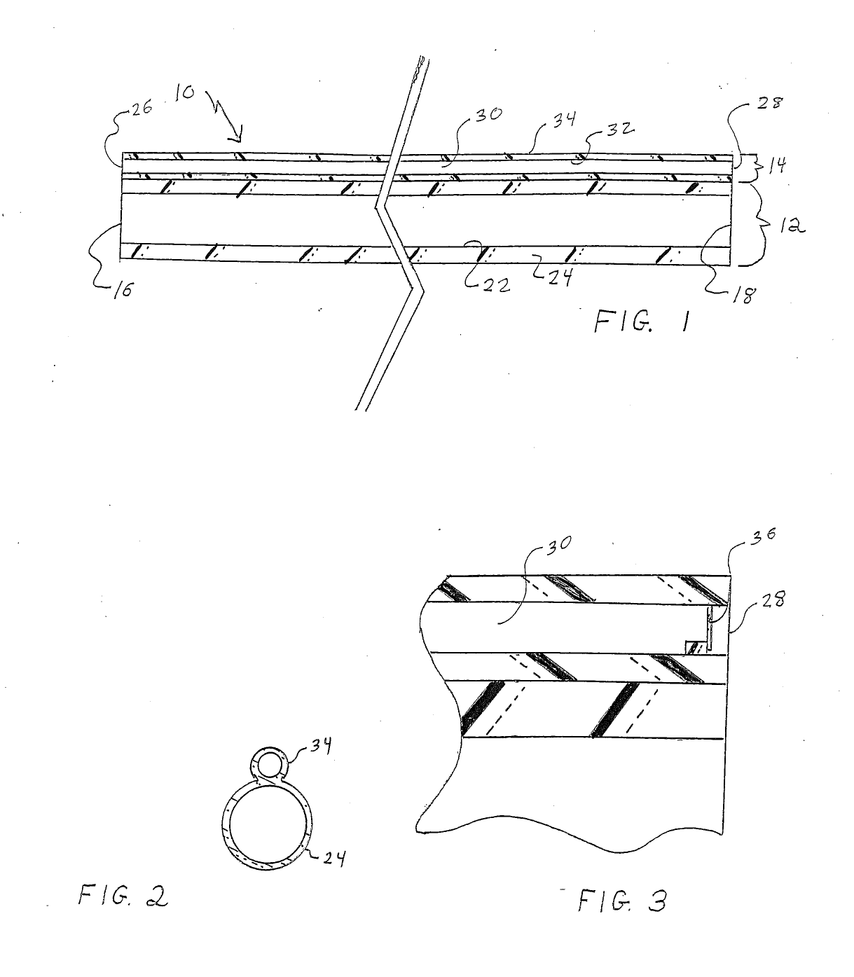

As shown in axial cross-section in FIG. 2, the first exterior wall surface 24 is adjacent to and integrally bonded to the second exterior wall surface 34. By integrally bonded, it is meant that the two tubes may not be separated without at least a partial rupture of one of the tubes. The two tubes may initially be two separate tubes and bonded together with an adhesive or with heat. Alternatively, the two tubes may be co-extruded as a single structure. Both tubes are formed from a suitable, flexible, biocompatible material. In making the tubes and other body components of the G-tubes, J-tubes and the like herein, it is within the scope of the invention to include reinforcing materials (metals, and composite fillers). In addition, additives for sterility (such as silver and the like) and for radiopacity may also be incorporated. Septum wall reinforcing metallic strips can also be used herein. The materials used to make the structural components may be those known in the art or to be developed for G-tube, J-tube, NG-tubes and other similar devices, such as various types of catheter tubing. Such materials may be formed, for example, from conventional elastomeric polyurethanes such as those sold under the trademarks ESTANE and PELLETHANE from The Lubrizol Corporation (Cleveland, Ohio) and Dow Chemical Company (Midland, Mich.), respectively. Other polymeric materials such as polyvinyl chloride, styrenic polymers such as KRATON® from Kraton Performance Polymers, Inc. (Houston, Tex.), polyacrylates, polyolefins, polyamides, polyesters, fluoropolymers, silicones, polyphosphazenes, perfluoroelastomers, fluroelastomers, and copolymers, derivatives, blends and alloys of such polymers may be used. Such materials are conventionally employed in the art to prepare such devices, and can be employed to fabricate the tubular components by extrusion, insert molding, mandrel techniques and other various methods. Coatings for strengthening, sterilization, radiopaque, acid-resistance and other special properties and additives as well to achieve such properties may also be used, such as polyp-xylene) polymer as described in WO 95/04564 incorporated with respect to the description of use of such polymer herein.

As shown in FIG. 3, the distal end 28 of the second tube 30 may include a one way valve 36 or other mechanism to prevent gastric material from flowing into the second tube when the rescue port is not being utilized.

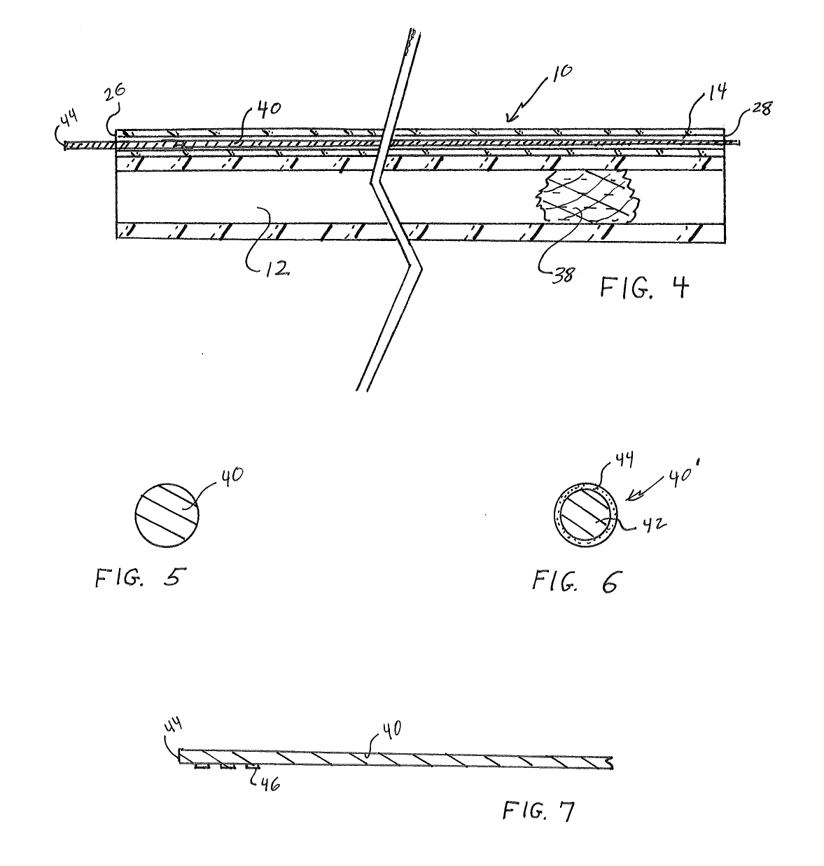

FIG. 4 illustrates enteral feeding tube 10 when the rescue port 14 is utilized. Typically, utilization of the rescue port 14 is due to a blockage 38, such as accumulated nutrients or drugs, preventing free flow through the first tube 12. A guide wire 40 is inserted into the second tube 30 from the proximal end 26 to the distal end 28. The guide wire 40 is manufactured from a biocompatible material having sufficient flexibility to follow the contours of the inserted enteral feeding tube 10, but sufficient rigidity to maintain its shape when the enteral feeding tube is removed. Referring to FIG. 5, a suitable guide wire 40 has a diameter effective to be received by the rescue port, meaning that there will be sufficient clearance for the wire to slide freely through the rescue port without excessive play. An exemplary guide wire had a diameter between 0.030 inch and 0.040 inch, and more preferably the diameter is from 0.035 inch and 0.038 inch. One suitable material for the guide wire 40 is stainless steel. With reference to FIG. 6, a second suitable material for the guide wire 40′ is a metallic core 42 coated with a hydrophilic polymer, that increases lubricity when in contact with water. An exemplary second suitable material is GLIDEWIRE® from Terumo Interventional Systems (Somerset, N.J.).

Typically, when the enteral feeding tube 10 needs to be replaced, an Interventional Radiologist will pass the guide wire 40 through the rescue port 14 from the proximal end 26 to the distal end 28 under real time x-ray or fluoroscopy. The enteral feeding tube 10 will then be removed while retaining the guide wire 40 in place. A new enteral feeding tube will then be placed over the wire. The wire “holds the place” of the feeding tube so the doctor does not need to establish a new access for the new tube, which is a more time consuming and difficult procedure. FIG. 7 illustrates proximal end 44 of the guide wire 40 may include indicia 46 to align with the proximal end 26 of the rescue tube 14 (FIG. 4). These indicia 46, may visual, tactile, or a combination thereof, and are used to insure the new feeding tube is inserted to the same depth as the removed feeding tube.

An alternative method to locate the distal end of the guide wire to insure the new feeding tube is inserted to the same depth does not require fluoroscopic guidance. The operator can confirm that the wire has exited the distal end of the rescue port and has entered the small bowel by using the indicia 46 on the proximal end 26 of the guide wire along with some further indication on the guide wire that it is definitely in the small bowel. This can be done using a characteristic of the wire that changes based on the pH of fluids contacting the distal end of the guide wire. For example, a color change on the guide wire that corresponds to the level of acidity in the small bowel contents, which is different than the acidity in the stomach. Proper positioning of the tube can then be confirmed with a simple x-ray rather than with a more involved fluoroscopic procedure.

One or more embodiments of the present invention have been described. Nevertheless, it will be understood that various modifications may be made without departing from the spirit and scope of the invention. For example, the tube may have application outside the human body, for unclogging plumbing pipes and for guiding fiber optic cables. Accordingly, other embodiments are within the scope of the following claims.

What is claimed is:

1. An enteral feeding device; comprising:
a first tube having a first proximal end, a first distal end, a first inner tube wall surface and a first exterior wall surface; and
a rescue port having a second proximal end, a second distal end, a second inner tube wall and a second exterior wall surface, wherein said first exterior wall surface is adjacent to and integrally bonded to said second exterior wall surface.

2. The enteral feeding device of claim 1 wherein said first tube and said rescue port are formed from biocompatible polymers.

3. The enteral feeding device of claim 2 wherein said first tube and said rescue port are bonded together.

4. The enteral feeding device of claim 2 wherein said first tube and said rescue port are coextruded.

5. The enteral feeding device of claim 2 wherein a one-way valve is disposed at said second distal end.

6. A combination of an enteral feeding device and a guide wire, comprising:
a first tube having a first proximal end, a first distal end, a first inner tube wall surface and a first exterior wall surface;
a rescue port having a second proximal end, a second distal end, a second inner tube wall and a second exterior wall surface, wherein said first exterior wall surface is adjacent to and integrally bonded to said second exterior wall surface; and
a guide wire having a diameter effective to be received by said rescue port.

7. The combination of claim 6 wherein said guide wire is formed from a biocompatible metal.

8. The combination of claim 7 wherein said biocompatible metal is coated with a hydrophilic polymer.

9. The combination of claim 7 wherein said guide wire has a diameter of between 0.030 inch and 0.040 inch.

10. The combination of claim 8 wherein said guide wire has a diameter of between 0.030 inch and 0.040 inch.

11. The combination of claim 7 wherein a proximal end of said guide wire includes indicia effective to locate said enteral feeding device.

12. The combination of claim 7 wherein a characteristic of said guide wire is affected by a pH of fluids contacting a distal end of said guide wire.

13. The combination of claim 12 wherein said characteristic is color.

14. The combination of claim 11 wherein a characteristic of said guide wire is affected by a pH of fluids contacting a distal end of said guide wire.

15. The combination of claim 14 wherein said characteristic is color.

16. A process to replace an enteral feeding device, comprising the steps of:
locating a first enteral feeding device in a patient, said first enteral feeding device having a first tube having a first proximal end, a first distal end, a first inner tube wall surface and a first exterior wall surface and a rescue port having a second proximal end, a second distal end, a second inner tube wall and a second exterior wall surface, wherein said first exterior wall surface is adjacent to and integrally bonded to said second exterior wall surface;
inserting a guide wire with a diameter effective to be received by said rescue port into said rescue port;
removing said first enteral feeding device while retaining said guide wire in place;
inserting a distal end of a second enteral feeding device rescue port around a proximal end of said guide wire; and
locating said second enteral feeding device in said patient.

17. The process of claim 16 wherein said first tube and said rescue port are both formed from biocompatible polymers.

18. The process of claim 17 wherein said guide wire is formed from a biocompatible metal.

19. The process of claim 18 wherein said guide wire has a diameter of between 0.030 inch and 0.040 inch.

20. The process of claim 19 wherein indicia effective to locate both said first enteral feeding device and said second enteral feeding device are formed on a proximal end of said guide wire.
